(19) United States
(12) Patent Application Publication
(10) Pub. No.: US 2013/0256481 A1
(43) Pub. Date: Oct. 3, 2013

(54) Ladder Accessory

(71) Applicant: Kayenta Saucier, Seymour, CT (US)

(72) Inventor: Kayenta Saucier, Seymour, CT (US)

(21) Appl. No.: 13/832,368

(22) Filed: Mar. 15, 2013

Related U.S. Application Data
(60) Provisional application No. 61/616,459, filed on Mar. 28, 2012.

(51) Int. Cl. E06C 7/14

(52) U.S. Cl. CPC E06C 7/143
USPC 248/210

(57) ABSTRACT

A ladder accessory device for insertion into an opening in a prior art ladder rung, wherein the ladder accessory device provides an elevated work environment that is out of the path of an individual ascending/descending the ladder. The accessory device is preferably comprised of a rung insert, a positive locking device, a support arm, and a platform arm. The positive locking device permits the support arm to be rotated and repositioned about the rung insert, and the platform arm is likewise rotatable and repositionable about and along the support arm. A wide arrange of accessories may also be removably attached to the platform to increase the overall usefulness of the device.

### CROSS-REFERENCE

This application claims priority from Provisional Patent Application Ser. No. 61/616,459 filed on Mar. 28, 2012.

### FIELD OF THE INVENTION

This invention relates to a ladder accessory for securely supporting a user's tools and materials alongside a ladder in an elevated work environment. More specifically, the ladder accessory is suspended from an open ladder rung on the exterior side of a ladder rail, and provides a work platform for the user to temporarily store his or her tools and other supplies in an elevated work environment. Because the accessory is positioned on the exterior side of a ladder rail, neither the accessory nor the tools and supplies stored thereon interfere with the user's ascending or descending the ladder. The ladder accessory is relatively easy to install and use, inexpensive to manufacture, and can be used in conjunction with a variety of ladders and to support a wide variety of tools, supplies and work platforms.

### BACKGROUND

Many individuals use ladders, such as extension ladders, to perform work on their homes and other structures, or to access elevated positions. For example, many individuals use an extension ladder to paint elevated portions of their homes, or to trim branches on a tree that could not be otherwise accessed from ground level. When working on a ladder, the individual typically requires access to a variety of tools and/or supplies. However, it can be both time consuming and dangerous for the individual to have to ascend and descend a ladder each time the individual requires a different tool or supply, particularly if the individual must use one of his or her hands to carry the tool or supply while ascending/descending the ladder.

To overcome such difficulties, some individuals will attempt to carry multiple tools and/or supplies up the ladder in a single trip and then attempt to position said tools and/or supplies on one or more of the ladder rungs. However, this practice is dangerous for a number of reasons. First, the items stored on the ladder rung create a climbing hazard for an individual ascending or descending the ladder. Additionally, the items stored on the ladder rung could fall from the ladder and cause damage to individuals or property below the ladder rung. Even if a falling tool or supply does not cause injury or property damage, it still necessitates the individual having to make an additional trip up and down the ladder to retrieve the fallen item.

In an attempt to overcome the aforementioned problems, other individuals may wear a tool belt or other harness to enable the individual to transport tools and/or supplies up and down a ladder and to store the tools and supplies when in an elevated work environment. However, tool belts and harnesses laden with tools can weigh an individual down or cause the individual to lose balance while ascending/descending a ladder. Tool belts also tend to be bulky and may limit the individual's mobility.

Consequently, there exists in the art a long-felt need for an accessory device that can be removably attached to a ladder, such as an extension ladder, and that can serve as an elevated work platform for the temporary storage of tools, supplies and other items. There also exists in the art a long felt need for an accessory work platform device that can be easily positioned and repositioned along the outside rail of a ladder and out of the path of an individual ascending/descending the ladder, thereby greatly improving safety without sacrificing accessibility. Finally, there is a long-felt need for an accessory device that accomplishes all of the forgoing objectives and that is relatively inexpensive to manufacture, aesthetically pleasing, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is a ladder accessory device useful for temporary storage of tools and other supplies in an elevated work environment and out of the path of an individual ascending/descending the ladder. The accessory device is preferably comprised of a rung insert, a positive locking device, a support arm, and a platform arm. The positive locking device permits the support arm to be rotated and repositioned about the rung insert, and the platform arm is likewise rotatable and repositionable about and along the support arm. A wide arrange of accessories may also be removably attached to the platform to increase the overall usefulness of the device.

The ladder accessory device of the present invention allows an individual to temporarily store a wide variety of tools and supplies in an elevated work environment, wherein said tools and supplies are easily accessible to the individual on the ladder but do not impede the individual's ability to freely and safely ascend/descend the ladder. The ladder accessory device is easily repositionable along the outside portion of the ladder rail, thereby enabling the individual to utilize the work platform at various elevations with minimal effort. Finally, the ladder accessory device of the present invention accomplish all of the forgoing objectives and is relatively inexpensive to manufacture, and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a prior art extension ladder with which the device of the present invention can easily be used.

FIG. 2 illustrates a perspective view of the accessory device of the present invention.

FIG. 2A illustrates an exploded perspective view of the positive locking device portion of the present invention.

FIG. 3 illustrates a perspective view of the accessory device of the present invention installed on the prior art extension ladder of FIG. 1.

FIG. 4 illustrates a perspective, cross-sectional view of the accessory device of the present invention.

FIG. 5 illustrates a perspective view of two accessory devices being used in tandem to support a work platform.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

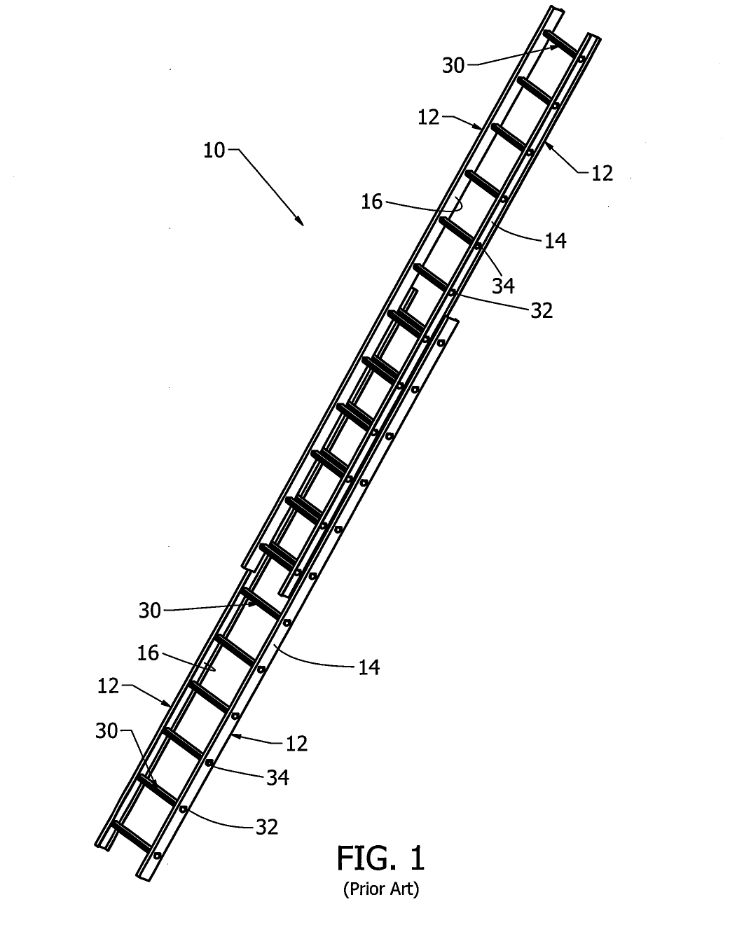

Referring initially to the drawings, FIG. 1 illustrates a perspective view of a prior art extension ladder 10. Each ladder portion of extension ladder 10 is preferably comprised of two rails 12 in spaced apart and generally parallel relationship to one another, and a plurality of rungs 30 that extend between and connect said rails 12 to one another. Each of rails 12 further comprise an exterior surface 14 that faces in the opposite direction of the opposing rail 12, an interior surface 16 that faces in the general direction of the opposing rail 12, and a plurality of openings in spaced apart relationship along rail 12. Each of said openings typically extend through rail 12 from exterior surface 14 to interior surface 16 for receipt of a rung 30.

Rungs 30 further comprise opposing end portions 32, and may be solid masses or hollow with a continuous opening 34 (typically oval, circular or generally D-shaped) therein that extends between end portion 32. Nonetheless, most ladders 10 have hollow rungs 30 to lessen the overall weight of the ladder and to lower manufacturing costs, as well as for other reasons. Ladder 10 is well known in the art and is available in many different embodiments including, without limitation, a single non-extendable ladder, extension ladders, step ladders, etc. While it is contemplated that the ladder accessory device of the present invention could be used with any prior art ladder 10 with a hollow rung 30, for purposes of discussion an extension ladder 10 is used as an example and is not meant to be a limitation.

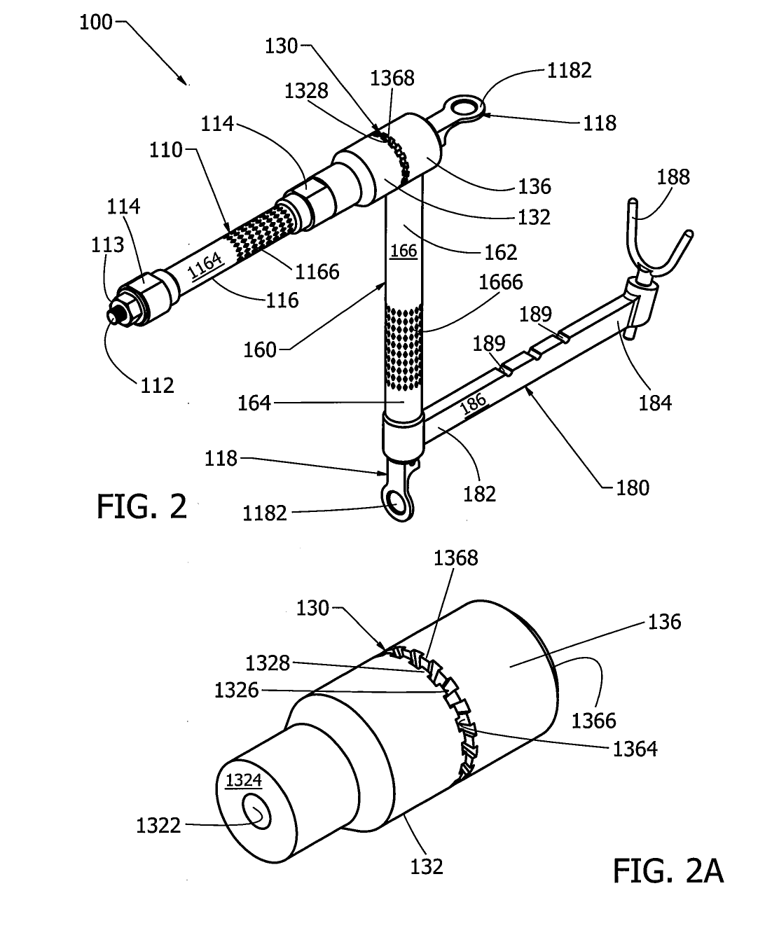

FIG. 2 illustrates a perspective view of a preferred embodiment of a ladder accessory device 100 of the present invention, which is useful for temporarily storing tools and supplies (not shown) in an elevated work environment and out of the path of an individual ascending/descending the ladder. Device 100 is preferably comprised of a rung insert 110, a positive locking device 130, a support arm 160 and a platform arm 180, each of which is described in more detail below. Unless otherwise stated herein, device 100 is preferably comprised of aluminum, or some other durable weather resistant material such as stainless steel or the like.

Rung insert 110 is preferably comprised of an elongated member 112, a stop block 113, a pair of expandable grips 114, a sleeve 116 positioned between said pair of expandable grips 114 and a cam lock 118. More specifically, elongated member 112 is comprised of a first end 1122 that extends outwardly from device 100 for insertion into continuous opening 34 of prior art ladder rung 30 as further described below, and a second end 1124. Stop block 113 may be either fixedly attached to the first end 1122, or integrally formed therewith, and is used to retain the other components of rung insert 110 along elongated member 112. For example, stop block 113 may be in the form of a nut threaded onto the first end 1122 of elongated member 112.

Expandable grips 114 are preferably formed of rubber, or some other compressible material, and have a continuous opening formed therein for receipt of elongated member 112. More specifically, expandable grips 114 are slidably repositionable along the length of elongated member 112, and a first of said expandable grips 114 is preferably positioned immediately adjacent to block 113. Sleeve 116 is generally tubular in shape and is also comprised of a continuous opening formed therein for receipt of elongated member 112, and an exterior surface 1164. As illustrated in FIG. 2, sleeve 116 is slidably repositionable along elongated member 112 between the expandable grips 114, and exterior surface 1164 may be scored or otherwise comprise a nonslip portion 1166 to permit secure handling of the device 100.

Positive locking device 130 is preferably slidably repositionable along elongated member 112 between expandable grip 114 and cam lock 118 adjacent to second end 1124, as illustrated in FIG. 2. Locking mechanism 130 preferably comprises a first portion 132 and a second portion 136. First portion 132 further comprises a continuous opening therein for receipt of elongated member 112, a first side surface 1324 facing in the general direction of first end 1122, and a second side surface 1326 facing in the general direction of second portion 136 and cam lock 118, as illustrated in FIG. 2A.

Similarly, second portion 136 further comprises a continuous opening therein for receipt of elongated member 112, a first side surface 1364 facing in the general direction of first portion 132, and a second side surface 1366 facing in the general direction of cam lock 118, as illustrated in FIGS. 2 and 2A. In a preferred embodiment of the present invention, second side surface 1326 of first portion 132 is further comprised of a plurality of radially spaced apart teeth 1328 for engaging a corresponding plurality of radially spaced apart teeth 1368 located on the first side surface 1364 of second portion 136 to prevent support arm 160 from rotating about elongated member 112 of rung insert 110 when cam lock 118 is in the locked position, as described more fully below.

First portion 132 is fixedly attached to elongated member 112 between expandable grip 114 and second portion 136. Second portion 136 is slidably and rotably positioned along elongated member 112 between first portion 132 and cam lock 118. As described more fully below, second portion 136 may be fixedly attached to, or integrally formed with support arm 160.

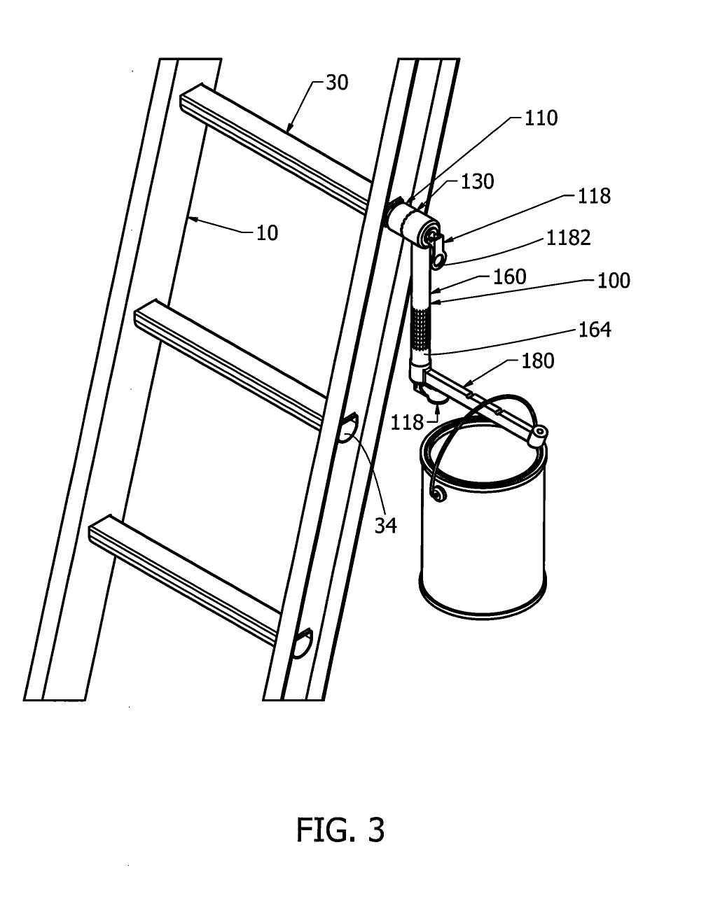

Cam lock 118 is well known in the art and commercially available at most hardware stores. Cam lock 118 is positioned at second end 1124 of elongated member 112 and further comprises a handle 1182 that is operable between a locked and an unlocked position. Cam lock 118 may be used to both removably secure device 100 to a prior art ladder 10, and to engage/disengage positive locking device 130. Importantly, and as described more fully below, the overall dimensions and shape of rung insert 110 should be sized to extend through continuous opening 34 in a ladder rung 30 as shown in FIG. 3. More specifically, expandable grips 114 should be shaped and sized accordingly so that when cam lock 118 is in an unlocked position expandable grips 114 are in an unexpanded state and are capable of being inserted into continuous opening 34 in ladder rung 30 along with the other components of rung insert 110. However, when cam lock 118 is in the locked position, thereby compressing the various items located along elongated member 112 and causing expandable grips 114 to expand in diameter, expandable grips 114 should engage the interior surface (not shown) of ladder rung 30 in a friction fit fashion to secure device 100 to prior art ladder 10. Stated differently, it should be relatively difficult to remove rung insert 110 from continuous opening 34 when cam lock 118 is in the locked position.

Support arm 160 is preferably an elongated member comprised of an upper end 162 positioned nearest to rung insert 110, a lower end 164 that extends outwardly from rung insert 110, and an exterior surface 166. Support arm 160 may be integrally formed with, or fixedly attached to, second portion 136. More specifically, second portion 136 is located at the upper end 162 of support arm 160, and is useful for radially positioning support arm 160 about elongated member 112 of rung insert 110 in a desired orientation.

A second cam lock 118 may be positioned at the lower end 164 of support arm 160 for removably attaching platform arm 180 to support arm 160, and permitting platform arm 180 to be radially repositioned about support arm 160. As previously stated, cam lock 118 is well known in the art and commercially available.

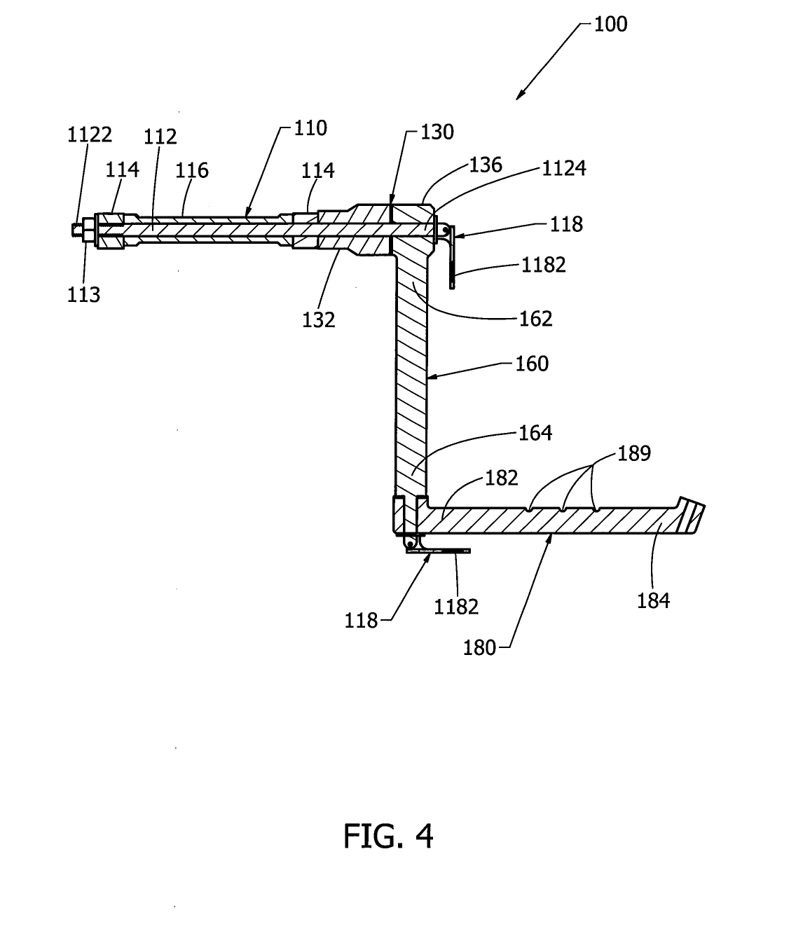

Platform arm 180 is preferably an elongated member comprised of an inboard end 182 positioned nearest to support arm 160, an outboard end 184 that extends outwardly from support arm 160, and an exterior surface 186. A wide variety of accessories 188 may be removably attached to outboard end 184 of platform arm 180. For example, FIG. 2 shows a fork like accessory 188 for supporting a cordless drill (not shown) attached to outboard end 184 of platform arm 180. Similar to exterior surface 1164 of sleeve 116, the exterior surfaces 166, 186 of support arm 160 and platform arm 180, respectively, may also be scored or otherwise comprise a nonslip portion 1166 to permit secure handling of device 100 or comprise one or more grooves 189 for receipt, for example, of a paint can handle or other device (not shown). FIG. 4 illustrates a perspective, cross-sectional view of the accessory device 100 of the present invention including, without limitation, platform arm 180.

The relationship of support arm 160 to rung insert 110 is such that support arm 160 is free to rotate about rung insert 110 when the handle 1182 of the cam lock 118 positioned on elongated member 112 is in an unlocked position and first and second portions 132, 136 of positive locking device 130 are disengaged. By comparison, when the handle 1182 of the cam lock 118 positioned on elongated member 112 is in a locked position and the teeth 1328, 1368 of first and second portions 132, 136, respectively, are engaged, expandable grips 114 are in an expanded state (meaning their respective diameters are enlarged) and support arm 160 is not free to rotate about elongated member 112.

Similarly, the relationship of platform arm 180 to support arm 160 is such that platform arm 180 is free to rotate about support arm 160 when the handle 1182 of the cam lock 118 positioned on support arm 160 is in an unlocked position. By comparison, when the handle 1182 of the cam lock 118 positioned on support arm 160 is in a locked position, platform arm 180 is not free to rotate about support arm 160. Notwithstanding the forgoing, it is contemplated that other devices for controlling and/or limiting the rotation of support arm 160 about rung insert 110 and/or platform arm 180 about support arm 160 could also be employed without impacting the overall concept of the present invention.

Having now described the overall structure of the accessory device 100 of the present invention, its use and usefulness will now be summarized. A user (not shown) desiring to use device 100 with a prior art ladder rung 30 with an opening 34 therein would simply ascend the ladder 10 to the desired height and insert rung insert 110 into opening 34 with the cam lock 118 located along rung insert 110 in an unlocked position (meaning that expandable grips 114 are in a relaxed or unexpanded state). Once rung insert 110 is positioned within opening 34 and support arm 160 is positioned in a desired orientation radially about rung insert 110, the user would move the cam lock handle 1182 to a locked position thereby causing (i) positive locking device to engage and prevent further rotation of support arm 160 about rung insert 110, and (ii) expandible grips 114 to expand and grip the interior surface of rung 30, thereby securing device 100 to prior art ladder 10 in a desired orientation. Moreover, the user (not shown) may then rotate platform arm 180 about support arm 160 into a desired position and move the handle 1182 of the cam lock 118 positioned at the lower end 164 of support arm 160 into a locked position to prevent further rotation of platform arm 180 about support arm 160. As illustrated in FIGS. 2, 3 and 5, accessory(ies) 188 may be removably attached to platform arm 180 to support, for example, tools and or materials.

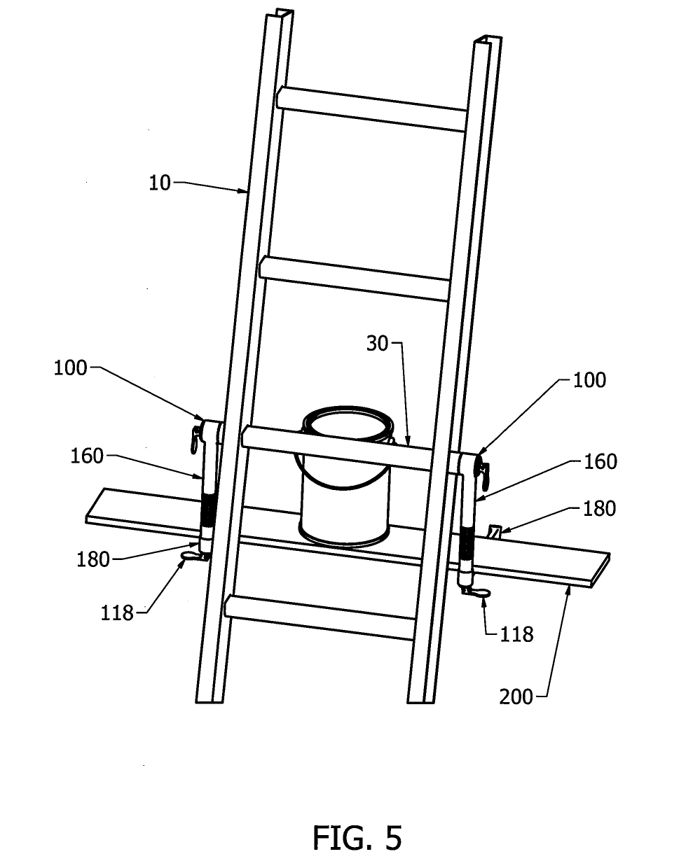

As illustrated in FIG. 5, it is also possible to insert two devices 100 into opening 34 of the same rung 30 from opposing sides to support a work platform 200 between the ladder 10 and the structure upon which it rests. More specifically, the platform arms 180 of each device 100 would be rotated about their respective support arm 160 so that they extend outwardly from the support arm 160 in approximately the same direction. Work platform 200 can then be placed on top of the two platform arms to form a work shelf or platform for tools, supplies and the like.

Consequently, the ladder accessory of the present invention enables a user to removably but securely attach the device to a ladder, such as an extension ladder, and function as an elevated work platform for the temporary storage of tools and supplies. The ladder accessory device of the present invention can also be relatively easily positioned and repositioned along the outside rail of a ladder and out of the path of an individual ascending/descending the ladder, thereby greatly improving safety without sacrificing accessibility. Finally, the ladder accessory device of the resent invention is relatively inexpensive to manufacture, and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A ladder accessory device comprising:
a rung insert;
a positive locking device;
a support arm; and
a platform arm.

2. The ladder accessory device of claim 1 wherein said support arm is capable of being rotated about said rung insert.

3. The ladder accessory device of claim 1 wherein said platform arm is capable of being rotated about said support arm.

4. The ladder accessory device of claim 1 wherein said rung insert further comprises at least one expandable grip.

5. The ladder accessory device of claim 4 wherein said at least one expandable grip is expanded within an opening in a ladder rung.

6. The ladder accessory device of claim 1 wherein said positive locking device is further comprised of a first portion and a second portion wherein only one of said first and second portions are rotatable about said rung insert.

7. The ladder accessory device of claim 1 wherein said rung insert further comprises a stop block, at least one expandable grip, and a cam lock for causing said at least one expandable grip to increase in size.

8. A ladder accessory device comprising:
a rung insert further comprising an elongated member and at least one expandable grip positioned along said elongated member for contacting an inner surface of a ladder rung;
a positive locking device for retaining a support arm that is rotatable about said elongated member in a desired position; and
a platform arm.

9. The ladder accessory device of claim 8 wherein said platform arm is capable of being rotated about said support arm.

10. The ladder accessory device of claim 8 wherein said positive locking device is further comprised of a first portion and a second portion wherein only one of said first and second portions are rotatable about said elongated member.

11. The ladder accessory device of claim 8 wherein said rung insert further comprises a stop block, a sleeve and a cam lock for causing said at least one expandable grip to increase in size.

12. The ladder accessory device of claim 11 wherein said stop block is comprised of a washer and an adjustable nut.

13. The ladder accessory device of claim 8 further comprised of a cam lock for controlling the rotation of said support arm about said elongated member.

14. The ladder accessory device of claim 9 further comprised of a cam lock for controlling the rotation of said platform arm about said support arm.

15. A ladder accessory device comprising:
a rung insert for insertion into a ladder rung;
a positive locking device for retaining a support arm that is rotatable about said rung insert in a desired orientation; and
a platform arm that is rotatable about said support arm.

16. The ladder accessory device of claim 15 wherein said rung insert is further comprised of an elongated member, a stop block, a pair of expandable grips, and a sleeve positioned between said pair of expandable grips.

17. The ladder accessory device of claim 15 further comprised of a cam lock for controlling the rotation of said support arm about said rung insert.

18. The ladder accessory device of claim 15 further comprised of a cam lock for controlling the rotation of said platform arm about said support arm.

19. The ladder accessory device of claim 15 wherein said rung insert further comprises at least one expandable grip for engaging said ladder rung.

20. The ladder accessory device of claim 15 wherein said positive locking device is further comprised of a first portion and a second portion wherein only one of said first and second portions are rotatable about said rung insert.
